(19) United States
(12) Patent Application Publication
(10) Pub. No.: US 2006/0154014 A1
(43) Pub. Date: Jul. 13, 2006

(54) Perforated tile cutting template

(76) Inventor: Michael Parkey, Denver, CO (US)

Correspondence Address: Sheridan Ross PC, Suite 1200, 1560 Broadway, Denver, CO, 80123, US

(21) Appl. No.: 11/033,592

(22) Filed: Jan. 11, 2005

(51) Int. Cl. G09F 3/00

(52) U.S. Cl. 428/43

(57) ABSTRACT

The present invention relates generally to devices that aid in the cutting and/or forming of a floor covering member. More specifically, one embodiment of the present invention is adapted to selectively interface with obstructions generally found in structures such as pillars, columns, door jams, fixtures, etc., that necessarily require the cutting of tiles. Often this cutting operation causes tiles to crack and/or otherwise be damaged wherein time and materials are generally wasted. The present invention accommodates the obstructions and forms a template that is placed on an uncut tile to define an accurate cut line, thus reducing the time and cost of a flooring operation.

### FIELD OF THE INVENTION

The present invention generally relates to a device that aids in the cutting, trimming, and shaping of floor, wall and ceiling surface coverings. One embodiment of the present invention is a selectively alterable template that engages a ceramic tile that distinctly indicates a cut line on the tile.

### BACKGROUND OF THE INVENTION

Various types of floor coverings are employed to protect the floor surface and to provide comfort to the inhabitants of a dwelling. Floor coverings such as carpet, tile, wood, linoleum, stone, brick, slate, plastic, rubber, (hereinafter “tile”) must often be cut, trimmed, or sanded prior to being placed because often obstructions prevent the placing of a single tile. These obstructions may be columns, door jams, fixtures, etc. When cutting, the tile is easily damaged or mis-cut, thus wasting the often expensive tile. More specifically, a tradesman generally “eyeballs” or measures the obstruction that is to be at least partially surrounded by a piece of tile, marks or scores the tile, and cuts the tile. The tile is then fitted against the obstruction and fine adjustments are made by a sander, for example. Commonly, during this process, the tile breaks and/or the cut is erroneous such that the tile is discarded, thus increasing the cost and time of the flooring project.

There are methods of decreasing the time and the cost of tiling a floor. One of these is U.S. Pat. No. 5,922,157 to Snider (hereinafter “Snider”). Snider describes a sheet that is selectively folded around an obstruction that aids in the cutting of the tile. One drawback of Snider is that the sheet must be physically cut with a scissors or other cutting device, which increases the possibility of human error. In addition, the extra step of cutting the sheet adds time and difficulty to the tiling operation.

Thus, there is a long felt need in the field of floor surface covering application to provide a device that aids in the alteration of the floor surface covering, such as tile, that decreases the waste of material and the installation time and cost.

### SUMMARY OF THE INVENTION

It is one aspect of the present invention to provide a sheet for selectively forming around an obstruction or a structure. Here, the obstruction being a fixture, molding, door frame, column, window, wall, pipe, vent, etc., that prevents the orderly placement of tiles on the floor or other surface. The sheet is used as a template for cutting or otherwise marking or scoring a flooring covering, which includes tile, wood, brick, linoleum, carpet, ceramics, slate, vinyl, cork, porcelain, tumbled stone and terra cotta. The sheet of one embodiment of the present invention is opaque and made out of a semi-rigid material, however one skilled in the art will appreciate that a transparent or semi-transparent material may be used without departing from the scope of the invention.

Another aspect of the present invention is to provide a sheet with a plurality of areas that are easily deformed and/or torn. More specifically, one embodiment of the present invention is provided with a plurality of a tear lines that are formed by a continuous line of perforations. These perforations make the semi-rigid material easy to bend around the obstruction. The perforations generally also make the sheet easy to tear to provide a template. One skilled in the art will appreciate that the perforations may be apertures of any shape and may be spaced in such a way to either impede or aid in the tearing of the sheet. More specifically, the smaller and further spaced apart the perforations, the more difficult the sheet will generally be to tear apart. Alternatively, dimples may be provided in the sheet, wherein a press or mold is used to selectively thin portions of the parent sheet thus making the sheet easier to deform and tear in the locally thinned regions. Further, cavities, channels, or grooves may be provided in the sheets at predetermined distances from each other. These grooves also make the sheet easy to bend along a groove.

The spacing and arrangement of the tear lines may be of any shape. More specifically, one embodiment of the present invention employs linear tear lines that are spaced a predetermined distance from each other and in a perpendicular fashion to provide a plurality of square removable segments. However, one skilled in the art will appreciate a sheet may contain variously spaced tear lines that provide rectangular and square removable segments. Some embodiments of the present invention employ arcuate tear lines to aid in the creation of templates for cutting tiles to fit around rounded obstructions. Further, some embodiments of the present invention employ a plurality of triangular shaped removable segments to aid in the formation of tiles around an angled obstruction. The removable segments may be of any size, wherein the smaller the individual removable segments, the more accurate the template will match the obstruction. Thus, one skilled in the art will appreciate that any size and shape of removable segment that is bounded by linear or non linear tear lines may be provided in order to accommodate any obstruction.

In a related aspect of the present invention, a sheet is provided that contains a plurality of different shaped removable segments. For example, one embodiment of the present invention contains at least two separate sections that contain entirely different removable segments, such that the sheet may be separated and used to accommodate different obstructions. In addition, the waste portion of the sheet, which will be described below, may be used again for smaller projects.

It is still yet another aspect of the present invention to employ a sheet that includes a surface of adhesive. This embodiment of the present invention is used to aid in the interconnection of the sheet to the tile. Here, the sheet remains affixed to the tile, before and after cutting, such that the template does not move when the tradesman is marking, scoring, cutting, or shaping the tile. The adhesive may be water based wherein the application of water will cause the sheet to be easily removed from the tile.

It is another aspect of the present invention to provide a plurality of sheets as described that are interconnected in a bound book. More specifically, one embodiment of the present invention is a plurality of interconnected sheets of constant or varying tear patterns such that the tradesman may easily remove a desired sheet while working. In a related aspect of the present invention, the sheets are individually packaged with the tile such that a box of 12 tiles may have at least 96 or more sheets included therewith. Alternatively, the sheets may be interconnected end-to-end and stacked in an accordion style or rolled.

One embodiment of the present invention is constructed of a semi-rigid material such as cardboard of predetermined length, width and thickness. However, one skilled in the art will appreciate that any material may be used without departing from the scope of the invention, such as paper, rubber, plastic, wax, or any other type of easily deformed and torn material. The areas that are adapted to be easily bent and torn, i.e. the tear lines, may be either cut, stamped, molded, punched, or otherwise integrated into the sheet. Alternatively, a plurality of shaped magnets maybe provided to form generally a magnetized sheet wherein portions thereof may be easily removed to form a template. The template would then be used to indicate the cut line of a tile. The removed magnet portions may then be reinserted after the tile is cut, wherein the sheet becomes whole for a subsequent use. Further, one skilled in the art will appreciate that any system of interlocking shapes may be used such that the sheet may be selectively altered wherein portions thereof are removed to be reformed at some subsequent time to create a sheet for use in a different application.

It is yet another aspect of the present invention to provide a method of cutting floor surface members, such as tiles. More specifically, one embodiment of the present invention utilizes a sheet with a plurality of perforated tear lines integrated thereon. The sheet is initially placed adjacent to formerly placed tiles and/or the obstruction, such as a pillar located adjacent to a wall. The sheet is then deformed and/or pieces are torn therefrom to create a template that accommodates the obstruction. The template is then placed on the tile wherein the tile is then scored or otherwise marked to indicate an accurate cutting line. The template is then used again to accommodate another obstruction or discarded.

Thus it is one aspect of the present invention to provide a sheet with a plurality of removable segments being separated by an area capable of deformation and tearing; and wherein a predetermined number of said removable segments are removed from said sheet thereby creating a template to be used in altering a floor surface member.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a front elevation view of one embodiment of the invention;

FIG. 2 is a detailed view of the embodiment shown in FIG. 1;

FIG. 3 is a cross sectional view of the embodiment shown in FIG. 1;

FIG. 4 is an alternate cross sectional view of the embodiment shown in FIG. 1;

FIG. 5 is an alternate cross sectional view of the embodiment shown in FIG. 1;

FIG. 6 is a front elevation view of an alternate embodiment of the invention;

FIG. 7 is a front elevation view of an alternate embodiment of the invention;

FIG. 8 is a front elevation view of an alternate embodiment of the invention;

FIG. 9 is a perspective view of a structure showing a plurality of placed tiles;

FIG. 10 is a perspective view showing one embodiment of the present intention placed adjacent to an obstruction;

FIG. 11 is a front elevation view of one embodiment of the present invention after it has been placed adjacent to the obstruction and selectively altered and/or torn; and

FIG. 12 is a front elevation view of the embodiment shown in FIG. 11 with a portion removed to form a template that aids in the cutting, trimming, grinding, sanding, and/or shaping of a ceramic tile.

To assist in the understanding of the present invention the following list of components and associated numbering found in the drawings is provided herein:

| # | Component |
|---|---|
| 2 | Sheet |
| 4 | Removable segment |
| 6 | Obstruction |
| 8 | Template |
| 10 | Tile |
| 12 | Tear line |
| 14 | Perforation |
| 16 | Dimple |
| 18 | Void |
| 20 | Floor |
| 22 | Wall |
| 24 | Interface portion |
| 26 | Excess portion |
| 28 | Cut line |
| ∝ | Segment angle |
| W | Sheet width |
| L | Sheet length |
| W′ | Segment width |
| L′ | Segment length |
| T | Sheet thickness |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

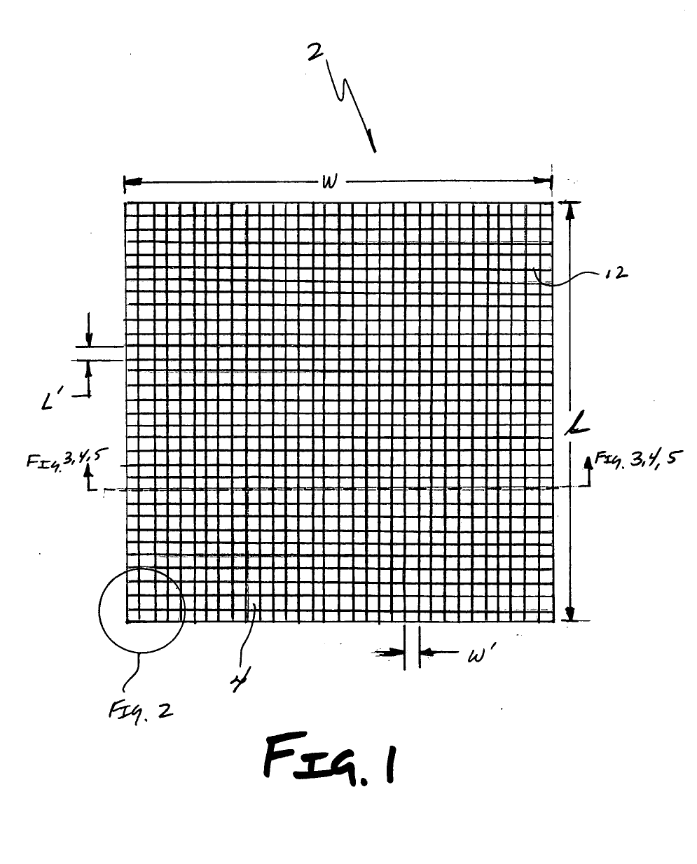

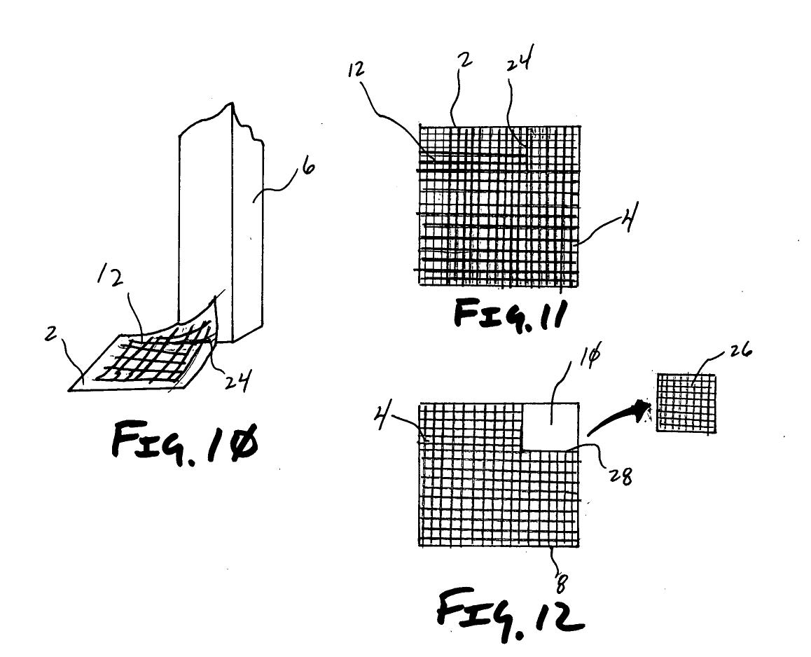

Referring now to FIGS. 1-12, a selectively alterable tile cutting template is shown. More specifically, one embodiment of the present invention is a generally square or rectangular sheet 2 that includes a plurality of removable segments 4. The sheet 2 is initially placed adjacent to an obstruction 6 on a surface to be tiled, and segments 4 thereof are selectively removed to form a template 8. The template 8 is then placed on a tile 10 to aid in cutting, scoring, trimming, sanding, grinding, etc.

Referring now to FIG. 1, one embodiment of the present invention is shown. More specifically, the sheet 2 of a predetermined length (L) and width (W) is shown that includes a plurality of removable segments 4 of length (L′) and width (W′). Here, the sheet 2 is square and the removable segments 4 are evenly spaced square portions, however, one skilled in the art will appreciate that any shaped sheet 2 or removable segment 4 may be provided without departing from the scope of the invention. The sheet 2 is designed to selectively deform and fold to accommodate the obstruction such that segments of the sheet 2 may be removed to create a template that aids in the cutting, scoring, marking etc. of a floor covering member.

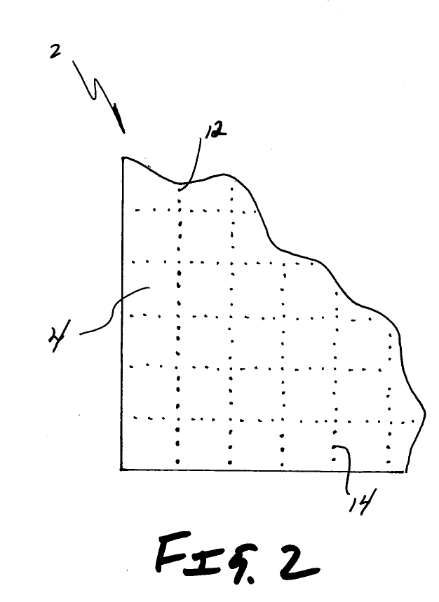

Referring now to FIG. 2, a detail of the embodiment of FIG. 1 is shown. More specifically, the tear lines 12 of the sheet 2 are shown that are spaced to create generally square removable segments 4. A number of perforations 14 or similar features that aid in folding or tearing are integrated into the sheet 2 to form the tear line 12. The perforations 14 may be spaced in various ways to either facilitate or inhibit tearing. More specifically, the farther apart the perforations 14 are spaced from each other, the more difficult it is to remove segments 4 from the sheet 2.

Referring now to FIG. 3, a cross-sectional view of the tear line of one embodiment of the present invention is shown. Here, dimples 16 are provided, which may be of any shape or size, that form the tear lines. The dimples 16 of this embodiment of the present invention may be easily cut or stamped into the flat sheet 2 of any thickness (T).

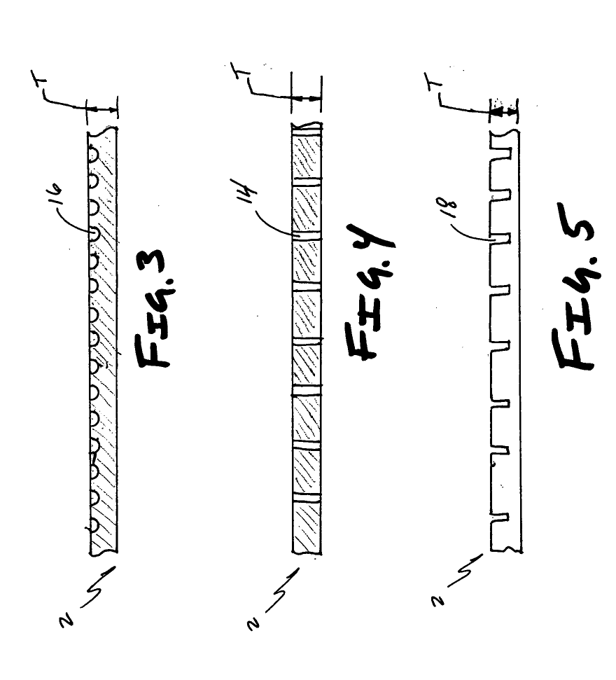

Referring now to FIG. 4, an alternate method of providing a tear line is shown. Here, perforations 14, which are tiny apertures that span the thickness (T) of the sheet 2 are shown. The spacing of the perforations 14 will dictate the ease of tearing the sheet 2. In addition, the thicker or more rigid the sheet 2, the more perforations 14 that will be required to provide an easily tearable sheet 2.

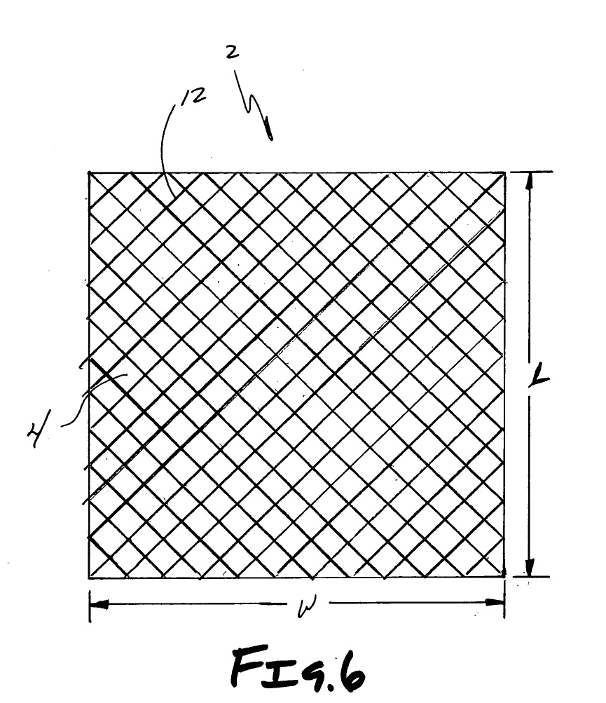

Referring now to FIG. 5, yet another method of providing a tear line is shown. In this embodiment, voids 18 or channels may be included that span the entire length and width of the sheet 2 or may be formed in singular discrete locations on the sheet 2 to provide thinned areas to increase the ease of bending and tearing.

Referring now to FIG. 6, another embodiment of the present invention is shown. More specifically, this embodiment utilizes tear lines 12 positioned perpendicular to each other and at a predetermined angle from the edges of the sheet 2. This embodiment illustrates that any shape, arrangement, and orientation of the removable segments 4 is possible, which should be appreciated by one skilled in the art. The sheet 2 of this embodiment of the present invention may be used, for example, where the obstruction has a square foot print with a diagonal that is parallel with a vertical surface, such as a wall. Here, an angled portion of the sheet is removed, therefore creating a template for an angled cut.

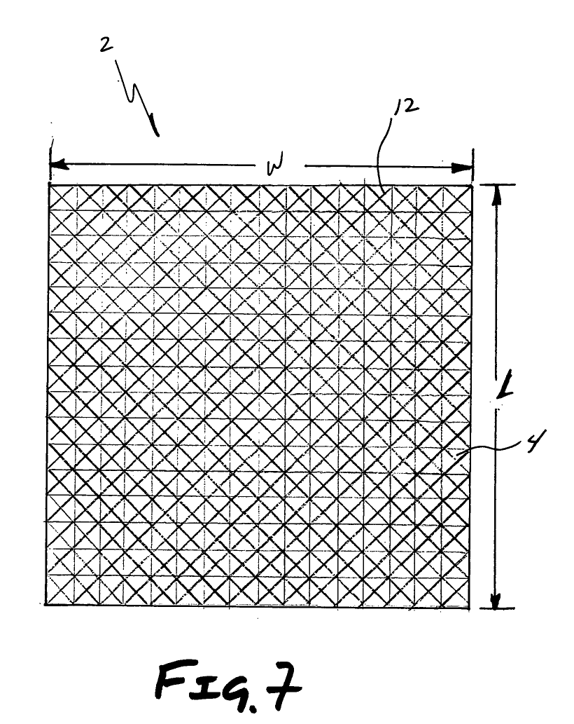

Referring now to FIG. 7, another embodiment of the present invention is shown. This embodiment includes a plurality of triangular removable segments 4. In addition, the vast possibilities that maybe provided with respect to creating a template for the trimming and/or cutting of a piece of tile is illustrated and should be apparent to one skilled in the art. Further, it is illustrated that as the removable segment 4 area is decreased, the conformability of the cut tile with respect to the obstruction is increased.

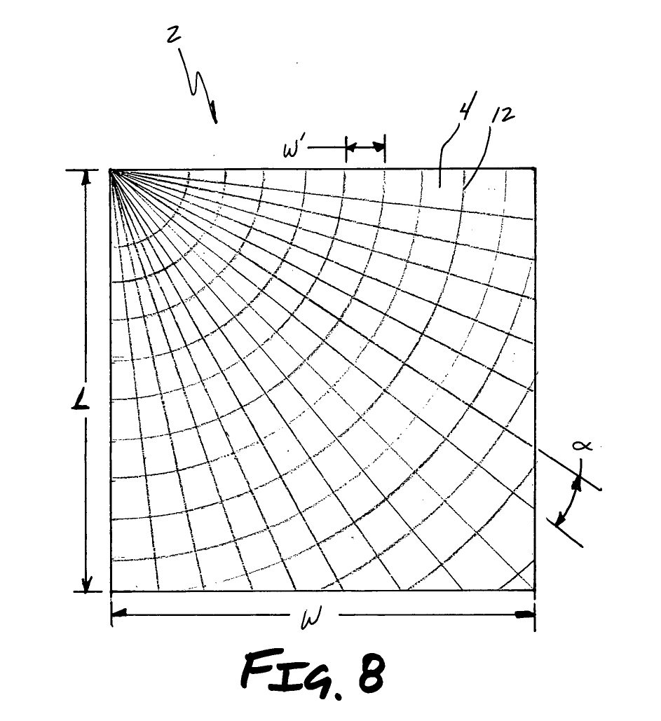

Referring now to FIG. 8, yet another embodiment of the present invention is shown. Here, a pattern of tear lines 12 similar to that of a spider web is provided, wherein arcuate tear lines 14 are provided that are separated by radially spaced (∝) straight tear lines. It is important to note, that the removable segments may be of any shape or size such that the sheet 2 may contain constant shaped segments 4 or, alternatively, segments of various sizes. In addition, the sheet 2 may contain areas of varying segments 4 such that a single sheet 2 may be used for various applications without having to discard unused portions of the sheet 2.

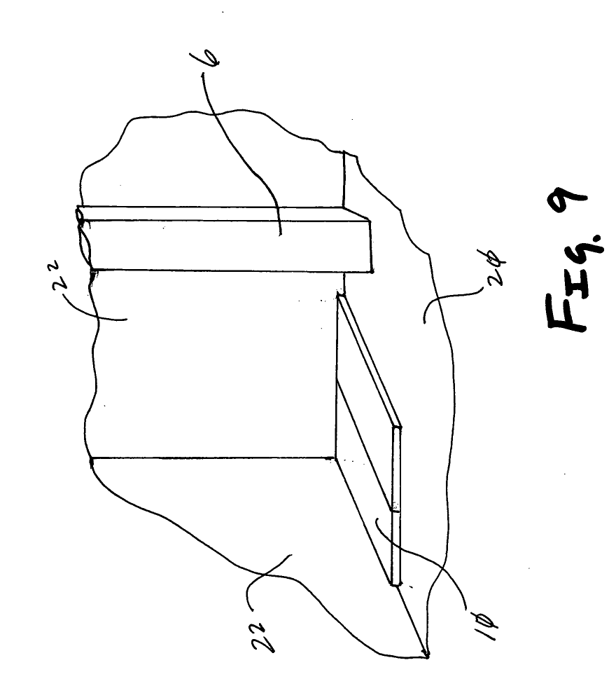

Referring now to FIG. 9-12, a method of using one embodiment of the present invention is shown. Referring specifically now to FIG. 9, a plurality of tiles 10 are placed on a floor 20 adjacent to two walls 22. In addition, an obstruction 6, for example, a column, is provided wherein the next tile to be placed must be cut so that it fits therearound. With emphasis now to FIGS. 10-12, in one embodiment of the present invention the sheet 2 is placed adjacent to the obstruction 6 and to a previously placed tile 10. In operation, the sheet 2 will generally deflect upward to accommodate the obstruction 6, wherein the sheet 2 is then folded or torn to distinctly indicate the interface portions 24 between the sheet 2 and the obstruction. The interface portions 24 define an excess portion 26 that is easily torn from the sheet 2 to reveal the template 8. The template 8 is then placed on the uncut tile 10 to define a cut line 28. One skilled in the art will appreciate that the template may be provided with an adhesive surface such that it is maintained on the tile 10 while marking and/or cutting. In addition, the excess portion 26 may be discarded or be used for other projects.

As shown herein, tiles for the interconnection to the floor 20 of a structure have been shown. However, one skilled in the art will appreciate that the present invention may be utilized with tiling or other similar coverings on any surface, such as the vertical surface around windows, without departing from the scope of the invention.

While various embodiment of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A device that aids in the cutting, marking, shaping, scoring, and trimming of a floor surface member comprising:
a sheet with a plurality of removable segments being separated by an area capable of deformation and tearing; and
wherein a predetermined number of said removable segments are removed from said sheet thereby creating a template adapted for altering a floor surface member.

2. The device of claim 1, wherein said plurality of removable segments are defined by spaced perpendicular, arcuate, and angled tear lines.

3. The device of claim 1, wherein said areas capable of deforming and tearing are formed of at least one of perforations, voids, grooves, channels and dimples.

4. The device of claim 1, wherein said device is adapted to be employed with at least one of ceramic tiles, linoleum tiles, stone, brick, wood tiles, wood flooring, carpeting, ceramics, slate, vinyl, cork, porcelain, tumble stone and terra-cotta.

5. The device of claim 1 in combination with a plurality of said sheets interconnected thereto, wherein individual sheets may be removed for use.

6. The device of claim 1, wherein said sheet further comprises an adhesive for bonding with a floor surface member.

7. The device of claim 1, wherein said sheet is shaped at least one of a square, a rectangle, a circle, an oval, a trapezoid, a triangle, a rhombus, a hexagon, and an octagon.

8. A method of cutting, marking, shaping, scoring, and trimming of a floor surface member comprising:
providing a sheet with a plurality of segments being separated by an area capable of deformation and tearing;
placing said sheet adjacent to an obstruction for which tiling is to be placed around;
selectively removing segments of said sheet to form a template;
placing said template onto said floor surface member; and
altering said floor surface member by performing a cutting, marking, shaping, scoring, and trimming along an edge of said template.

9. The method of claim 8 further comprising selectively deforming said sheet generally along said area to accommodate said obstruction.

10. The method of claim 8, wherein said plurality of removable segments are defined by at least one of spaced perpendicular, arcuate, and angled tear lines.

11. The method of claim 8, wherein said areas capable of deforming and tearing are formed of at least one of perforations, voids, groove, channels and dimples.

12. The method of claim 8, wherein said device is adapted to be employed with at least one of ceramic tiles, linoleum tiles, wood tiles, stone, slate, brick, wood flooring, carpeting, ceramics, slate, vinyl, cork, porcelain, tumble stone and terra-cotta.

13. The method of claim 8 further comprising removing said sheet from at least one of a plurality of bound or contained sheets.

14. A device that aids in the cutting, marking, shaping, scoring, and trimming of a floor surface member comprising:
a generally square sheet with at least one removable segment being bounded by an area capable of deformation and tearing; and
wherein said at least one removable segment is removed from said sheet thereby creating a template adapted for altering a floor surface member.

15. The device of claim 14, wherein said at least one removable segment is bounded by at least one of a tear line perpendicular to an edge of said sheet, an arcuate tear line and a tear line that is angled with respect to said edge.

16. The device of claim 14, wherein said areas capable of deforming and tearing are formed of at least one of perforations, voids, grooves, channels and dimples.

17. The device of claim 14, wherein said sheet is at least about eleven inches wide by 11 inches long.

18. The device of claim 14, wherein said sheet includes at least about 2,200 said removable segments.

19. The device of claim 14, wherein said plurality of removable segments each are generally square being at least about 0.25 inches by 0.25 inches in dimension.
